(19) United States
(12) Patent Application Publication
(10) Pub. No.: US 2019/0099629 A1
(43) Pub. Date: Apr. 4, 2019

(54) FOAM FIRE SUPPRESSANT SYSTEM

(71) Applicant: RKO Enterprises, Madison, IN (US)

(72) Inventor: Kieth Olson, Madison, IN (US)

(21) Appl. No.: 16/146,050

(22) Filed: Sep. 28, 2018

Related U.S. Application Data
(60) Provisional application No. 62/566,588, filed on Oct. 2, 2017.

(51) Int. Cl. A62C 35/68; A62C 5/02

(52) U.S. Cl. CPC A62C 35/68; A62C 5/02

(57) ABSTRACT

A fire suppressing system having a water source, a foam agent source, and a pump having an inlet and a discharge. Wherein the water source is mixed with the foam agent source before entering the inlet of the pump.

### TECHNICAL FIELD

The present teachings are related to a fire pump apparatus, and in particular a fire pump apparatus with a foam agent delivery system.

### BACKGROUND

In the fire suppressant industry, it is important to contain and stop fires as quickly and efficiently as possible. Fire-suppressant foam has become a useful tool in quenching the fire, coating the fuel, and preventing contact with oxygen. Modern fire pumps utilize various foam delivery systems that introduce the foam on the discharge side of the pump. Introducing foam at the discharge side of the pump requires the foam agent to be introduced into the discharge at a pressure that is equal to or greater than a discharge pressure. Accordingly, many contemporary foam delivery systems require pressurization of the foam agent prior to entering the discharge.

### SUMMARY

One embodiment may be a fire suppressing system having a water source, a foam agent source, and a pump having an inlet and a discharge. Wherein the water source is mixed with the foam agent source before entering the inlet of the pump.

In one aspect of this example, the water source is selectable between a water tank and an auxiliary water source.

In another example, the foam agent source is fluidly coupled to the inlet via an orifice at the inlet.

In yet another example, the foam agent source has a foam agent pump fluidly coupled thereto.

In another example, the water source comprises a water tank and an auxiliary water source, wherein the inlet of the pump is selectively fluidly coupled to the water tank and the auxiliary water source. One aspect of this example includes a water cutoff valve positioned between the water tank and the inlet that selectively fluidly couples the water tank to the inlet. A further aspect of this example includes an auxiliary cutoff valve positioned between the auxiliary water source and the inlet that selectively fluidly couples the auxiliary water source to the inlet.

In one example the pump is a centrifugal pump.

Another example includes a water cutoff valve that selectively couples the water source to the pump.

In yet another example, a foam agent cutoff valve selectively couples the foam agent source to the pump.

A final example includes a water cutoff valve that selectively couples the water source to the pump, a foam agent cutoff valve that selectively couples the foam agent source to the pump, and a controller that selectively controls the water cutoff valve and the foam agent cutoff valve. Wherein the controller transitions the water cutoff valve and the foam agent cutoff valve between a fluidly coupled position and a fluidly isolated position to alter a water and foam mixture of the discharge.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a schematic view of a centrifugal fire pump system;

Corresponding reference numerals are used to indicate corresponding parts throughout.

### DETAILED DESCRIPTION

The above-mentioned aspects of the present application and the manner of obtaining them will become more apparent and the teachings of the present application itself will be better understood by reference to the following description of the embodiments of the present application taken in conjunction with the accompanying drawings.

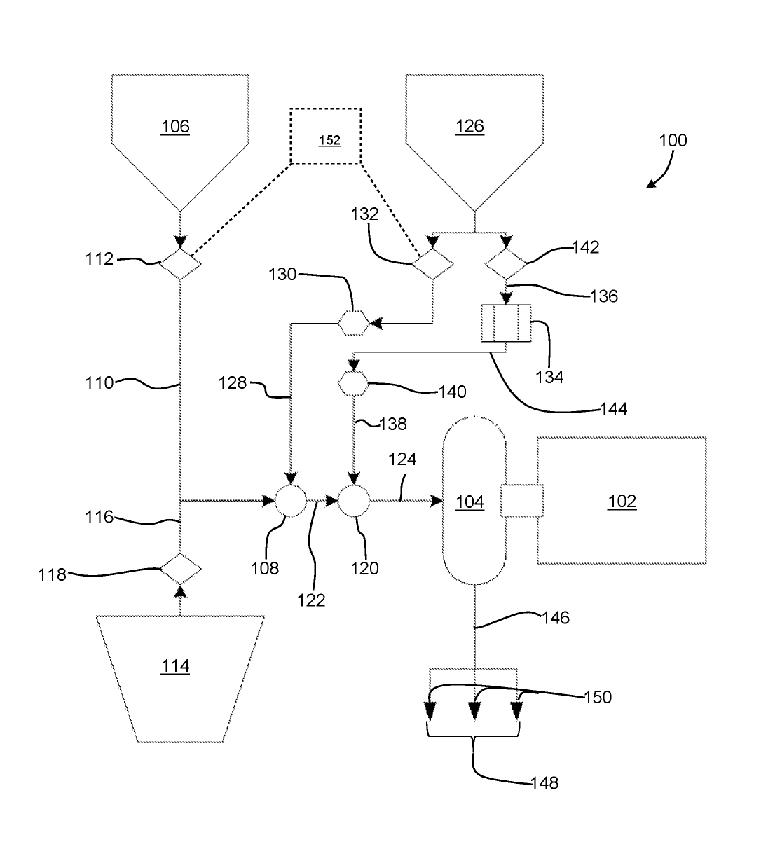

Referring to FIG. 1, one non-exclusive example of a fire pump apparatus 100 is shown. The fire pump apparatus 100 may have a water tank 106 fluidly coupled to an inlet 124 of a pump 104. The pump 104 may further be configured to selectively provide pressurized fluid to one or more discharges 148. The fire pump apparatus 100 may also have a foam agent reservoir 126 that is fluidly coupleable to the inlet 124 of the pump 104. The fire pump apparatus 100 draws water from the water tank 106 and foam agent from the reservoir 126 and discharges the water/foam mixture through the discharges 148. The fire pump apparatus 100 includes a series of pipes designed to direct fluid (water, foam agent, or water/foam mixture) throughout the fire pump apparatus 100. The fire pump apparatus 100 further includes a motor 102 mechanically coupled to the pump 104 to facilitate the movement and discharge of the fluid.

The motor 102 may be any type of motor capable of powering a fluid pump. In one embodiment, the motor 102 is a diesel or gas internal combustion engine. In a different embodiment, the motor 102 is an electric motor sufficiently sized to meet the demands of the fire pump apparatus 100. Further still, the motor may be a hydraulic motor powered by a hydraulic system. In another embodiment, the pump 104 may be powered by a power take-off of a vehicle. A person skilled in the relevant art understands the many different types of motors that can be used to power the pump 104, and this disclosure considers utilizing any known type of motor.

In one non-limiting example, the pump 104 may be a centrifugal-type pump. The inlet 124 may have a relatively low pressure compared to the outlet 146. In this embodiment, mixing the foam agent with the water at the inlet 124 rather than at the outlet 146 allows the foam agent to be mixed with the water under lower pressure conditions than if the foam agent was introduced at the outlet pipe 146 or otherwise at the outlet of the pump. While a centrifugal-type pump is described herein, this disclosure is not limited to any particular type of pump and any fluid pump is considered.

The water tank 106 may be coupled to a first orifice 108 via a first inlet pipe 110 such that water flows from the water tank 106 through the first inlet pipe 110 to the first orifice 108. Along the first inlet pipe 110, between the water tank 106 and the first orifice 108, there may be a water cutoff valve 112. The water cutoff valve 112 has an opened position and a closed position and is configured to manage the flow of water from the water tank 106. In the closed position, the water cutoff valve 112 fluidly isolates the water tank 106 from the first orifice 108 and in the opened position the water cutoff valve 112 fluidly couples the water tank with the first orifice 108. When a user requires water flow from the water tank 106, the water cutoff valve 112 is moved to the opened position. Alternatively, when a user does not require water flow from the water tank 106, the water cutoff valve 112 is moved to the closed position.

Alternatively, the water source providing water for the fire pump apparatus 100 may be an auxiliary water source 114. In one non-exclusive example the auxiliary water source 114 may be a fire hydrant or any other water source known in the art. The auxiliary water source 114 may be coupled to the first orifice 108 via a second inlet pipe 116 such that water flows from the auxiliary water source 114 through the second inlet pipe 116 to the first orifice 108.

Along the second inlet pipe 116, between the auxiliary water source 114 and the first orifice 108, there may be an auxiliary water cutoff valve 118. The auxiliary water cutoff valve 118 is configured to manage the flow of water from the auxiliary water source 114. In the closed position, the auxiliary water cutoff valve 118 fluidly isolates the auxiliary water source 114 from the first orifice 108 and in the opened position the auxiliary water cutoff valve 118 fluidly couples the auxiliary water source 114 with the first orifice 108. When a user requires water flow from the auxiliary water source 114, the auxiliary water cutoff valve 118 is moved to the opened position, and when a user does not require water flow from the auxiliary water source 114, the auxiliary water cutoff valve 118 is moved to the closed position.

The fire pump apparatus 100 further includes a second orifice 120 coupled to the first orifice 108 via an orifice connector pipe 122. Further, the second orifice 120 is connected to the pump 104 via the inlet 124. The first and second orifices 108, 120 are openings located at pipe junctions and may be locations for the foam agent to be introduced to water flowing to the pump 104 prior to entering the pump inlet 124 and the pump 104. While the first orifice 108 and the second orifice 120 are described herein as being two separate components, this disclosure also considers embodiments where the first and second orifice 108, 120 are substantially the same orifice. In other words, a single orifice can provide a location to introduce the foam agent to the water flow prior to entering the pump 104.

In one aspect of this disclosure, the foam agent reservoir 126 may contain a foam agent or the like used to suppress different types of fires. More specifically, the foam agent may be synthetic foams (including aqueous film forming foams and alcohol-resistant aqueous film-forming foams), protein foams (including regular protein foam, fluoroprotein foam, film-forming fluoroprotein foam, alcohol resistant fluoroprotein foam, and alcohol-resistant film-forming fluoroprotein foam), or any other natural or synthetic foam agent known in the art. Further, as will be described in more detail below, the flow rate of the foam agent to the corresponding orifice 108, 120 may be altered to accommodate different types of foam agents or the like.

The foam agent reservoir 126 is coupled to the first orifice 108 via a first routing pipe system 128. Along the first routing pipe system 128, between the foam agent reservoir 126 and the first orifice 108, there may be a first meter valve 130. The first meter valve 130 can be a quarter turn ball-type valve that is mechanically controlled. Further, the first meter valve 130 may be designed to modify the flow of foam agent from the foam agent reservoir 126 to the first orifice 108.

Between the foam agent reservoir 126 and the first meter valve 130 there may also be a first foam agent cutoff valve 132. The first foam agent cutoff valve 132 may manage the flow of foam agent from the foam agent reservoir 126 through the first routing system 128. For example, the first foam agent cutoff valve 132 can be designed to move to an open position when a user desires foam agent flow through the first routing pipe system 128, and to move into a closed position when a user does not desire foam agent flow through the first routing pipe system 128. In one embodiment, the flow of foam agent through the first routing pipe system 128 can be driven by gravitational force.

In one non-exclusive aspect of this embodiment, the first foam agent cutoff valve 132 may allow the flow of foam agent in one direction. For example, the first foam agent cutoff valve 132 may allow for foam agent to flow away from the foam agent reservoir 126, but not back into the foam agent reservoir 126. The one-way orientation of the first foam agent cutoff valve 132 ensures that fluid flow is directed towards the pump inlet 124 even when pressure in the first and second inlet pipes 110, 116 is greater than the pressure in the first routing pipe 128. In other words, the first foam agent cutoff valve 132 does not allow backpressure to force fluid from the water tank 106 or auxiliary water source 114 into the foam agent reservoir 126.

Similarly, the foam agent reservoir 126 is coupled to the second orifice 120 via a second routing pipe system 144. The second routing pipe system 144 includes a foam agent pump 134 coupled to the foam agent reservoir 126 via a first foam pipe section 136. Along the first foam pipe section 136, there may be a second foam agent cutoff valve 142. The second foam agent cutoff valve 142 manages the flow of foam agent from the foam agent reservoir 126 through the second routing pipe system 144. For example, the second foam agent cutoff valve 142 can be transitioned to an open position that fluidly couples the foam agent reservoir 126 to the foam agent pump 134 when the user desires foam agent flow through the second routing pipe system 144. Further, the second foam agent cutoff valve 142 may be moved into a closed position fluidly isolating the foam agent reservoir 126 from the foam agent pump 134 through the second routing pipe system 144 when the user does not desire foam agent flow through the second routing pipe system 144.

Similar to the first foam agent cutoff valve 132, the second foam agent cutoff valve 142 may be designed to allow the flow of foam agent in one direction. For example, the second foam agent cutoff valve 142 may be a one-way valve that allows for foam agent to flow away from the foam agent reservoir 126, but not back into the foam agent reservoir 126. The one-way orientation of the second foam agent cutoff valve 142 ensures that fluid flow is directed towards the pump inlet 124 even when pressure in the first and second inlet pipes 110, 116 is greater than the pressure in the second routing pipe system 144. In other words, the second foam agent cutoff valve 142 does not allow backpressure to force fluid from the water tank 106 or auxiliary water source 114 into the foam agent reservoir 126.

The foam agent pump 134 may be fluidly coupled to the second orifice 120 via a second foam pipe section 138. Along the second foam pipe section 138, there may be a second meter valve 140. The second meter valve 140 can be a quarter turn ball-type valve that is mechanically controlled and designed to modify the flow of foam agent from the foam agent pump 134 to the second orifice 120. Further, the foam agent pump 134 may be designed to facilitate movement of the foam agent from the foam agent reservoir 126 to the second orifice 120. In one exemplary embodiment, the foam agent pump 134 may be a fluid pump powered by a twelve-volt electric motor, however other motors and pump types are also considered herein.

As illustrated in FIG. 1, the inlet pipe 124 can feed the foam/water mixture into the pump 104. Further, the pump 104 is coupled to an outlet pipe 146. The outlet pipe 146 is designed to transport the foam/water mixture from the pump 104 to one or more discharges 148. The one or more discharges 148 can be coupled to a one or more discharge cutoff valves 150. The one or more discharge cutoff valves 150 may control the discharge of the foam/water mixture. When at least one of the one or more discharge valves 150 is in the open position, the foam/water mixture can discharge from the one or more discharges 148. When all of the one or more discharge valves 150 are in the closed position, the foam/water mixture is not discharged.

The discharge valves 150 can be any type of discharge valve known in the art. More specifically, in one embodiment the discharge valves 150 may be a series of sprinkler type valves configured to discharge the water foam agent mixture under certain circumstances. In other words, the discharge valves 150 may be part of a sprinkler system for a commercial or residential structure. In other embodiments, the discharge valves 150 may be a single valve like one on the end of a hose or the like. The discharge valve 150 may be selectively opened or closed by a user to direct the water/foam agent mixture from the hose. A person having skill in the relevant art understands the many ways a fire suppressing mixture can be discharged to suppress a fire, and this disclosure is not limited to any particular discharge method.

Demonstrated in FIG. 1, the first routing pipe system 128 may provide a primary flow of foam agent to the first orifice 108 in order to create a sufficient foam to water mixture ratio prior to entering the pump 104. However, the second routing pipe system 144 may be a supplemental path for the foam agent to mix at the second orifice 120 if additional foam agent is required to balance the foam to water ratio. In the event that the upper routing pipe system becomes damaged or is insufficient to supply enough foam agent for the proper foam to water ratio, the second routing pipe system 144 may become the primary path for the foam agent. In the event that there is an improper foam to water ratio due to an excess of foam agent, one or both of the first and/or second foam agent cutoff valves 132, 142 may be moved into the closed position, thereby fluidly restricting the flow of foam agent through the first and/or second routing pipe system 128, 144.

The foam agent reservoir 126 may house any of the abovementioned foam agents and different foam agents may be housed in the foam agent reservoir 126 at different times depending on the needs of the user. For example, Class A fires require a certain type of foam agent at about 1% or less mixture of the total volume of water. Alternatively, class B fires require a different foam agent at about 1%, 3%, or 6% mixture of the total volume of water. Accordingly, this disclosure considers many different types of foam agents or the like in the foam agent reservoir 126 to allow the fire pump apparatus 100 to be utilized for fighting many different types of fires.

In an alternate embodiment of the present disclosure, a controller 152 may be used to electronically manipulate the valves 112, 118, 130, 132, 140, 142, 150 depending on the desired function. For example, a user may be able to input certain parameters and circumstances and the controller would be able to electronically open or close certain valves 112, 118, 130, 132, 140, 142, 150 in order to meet the needs of the user. In one non-limiting example, the user may input that a fire hydrant is being used and the fire is a class B fire requiring 6% foam to water ratio. The controller may be programmed to close the water cutoff valve 112, open the auxiliary water cutoff valve 118, open the first and second foam cutoff valves 132, 142 and wait for a command to open the one or more discharge cutoff valves 150.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations).

What is claimed is:

1. A fire suppressing system, comprising:
a water source;
a foam agent source; and
a pump having an inlet and a discharge;
wherein the water source is mixed with the foam agent source before entering the inlet of the pump.

2. The fire suppressing system of claim 1, further wherein the water source is selectable between a water tank and an auxiliary water source.

3. The fire suppressing system of claim 1, further wherein the foam agent source is fluidly coupled to the inlet via an orifice at the inlet.

4. The fire suppressing system of claim 1, further wherein the foam agent source has a foam agent pump fluidly coupled thereto.

5. The fire suppressing system of claim 1, further wherein the water source comprises a water tank and an auxiliary water source, wherein the inlet of the pump is selectively fluidly coupled to the water tank and the auxiliary water source.

6. The fire suppressing system of claim 5, further comprising a water cutoff valve positioned between the water tank and the inlet that selectively fluidly couples the water tank to the inlet.

7. The fire suppressing system of claim 6, further comprising an auxiliary cutoff valve positioned between the auxiliary water source and the inlet that selectively fluidly couples the auxiliary water source to the inlet.

8. The fire suppressing system of claim 1, further wherein the pump is a centrifugal pump.

9. The fire suppressing system of claim 1, further comprising a water cutoff valve that selectively couples the water source to the pump.

10. The fire suppressing system of claim 1, further comprising a foam agent cutoff valve that selectively couples the foam agent source to the pump.

11. The fire suppressing system of claim 1, further comprising:
a water cutoff valve that selectively couples the water source to the pump;
a foam agent cutoff valve that selectively couples the foam agent source to the pump; and
a controller that selectively controls the water cutoff valve and the foam agent cutoff valve;
wherein the controller transitions the water cutoff valve and the foam agent cutoff valve between a fluidly coupled position and a fluidly isolated position to alter a water and foam mixture of the discharge.

12. A method for suppressing a fire, the method comprising:
providing a water source, a foam agent source, and a pump having an inlet and a discharge;
mixing the water source with the foam agent source before entering the inlet of the pump; and
dispensing the water source and foam agent source mixture out of the discharge.

13. The method for suppressing a fire of claim 12, further comprising selecting one of a water tank and an auxiliary water source as the water source.

14. The method for suppressing a fire of claim 12, further comprising fluidly coupling the foam agent source to the inlet via an orifice at the inlet.

15. The method for suppressing a fire of claim 12, further comprising positioning a foam agent pump between the foam agent source and the inlet of the pump.

16. The method for suppressing a fire of claim 12, further comprising providing a water tank and an auxiliary water source and coupling the inlet of the pump to one of the water tank or the auxiliary water source.

17. The method for suppressing a fire of claim 16, further comprising providing a water cutoff valve positioned between the water tank and selectively fluidly coupling the water tank to the inlet.

18. The method for suppressing a fire of claim 17, further comprising providing an auxiliary cutoff valve positioned between the auxiliary water source and the inlet and selectively fluidly coupling the auxiliary water source to the inlet.

19. The fire suppressing system of claim 1, further wherein the pump is a centrifugal pump.

20. A fire suppressing system, further comprising:
a water source;
a foam agent source;
a pump having an inlet and a discharge;
a water cutoff valve that selectively couples the water source to the pump;
a foam agent cutoff valve that selectively couples the foam agent source to the pump; and
a controller that selectively controls the water cutoff valve and the foam agent cutoff valve;
wherein, the controller transitions the water cutoff valve and the foam agent cutoff valve between a fluidly coupled position and a fluidly isolated position to alter a water and foam mixture of the discharge;
further wherein, the water source is mixed with the foam agent source before entering the inlet of the pump.
